(19) United States
(12) Patent Application Publication
(10) Pub. No.: US 2025/0101283 A1
(43) Pub. Date: Mar. 27, 2025

(54) POLYCRYSTALLINE DIAMOND COMPACT AND PREPARATION METHOD THEREFOR, AND CEMENTED CARBIDE SUBSTRATE

(71) Applicant: HAIMINGRUN CO., LTD., Shenzhen, Guangdong (CN)

(72) Inventors: Shaoqian HE, Shenzhen (CN); Baishu LIU, Shenzhen (CN); Lijun KONG, Shenzhen (CN); Dameng GUO, Shenzhen (CN)

(73) Assignee: HAIMINGRUN CO., LTD., Shenzhen, Guangdong (CN)

(21) Appl. No.: 18/564,284

(22) PCT Filed: Sep. 18, 2023
(86) PCT No.: PCT/CN2023/119506

§ 371 Date: Nov. 27, 2023

(30) Foreign Application Priority Data
Apr. 14, 2023 (CN) 202310425063.0

(51) Int. Cl. C09K 3/14

(52) U.S. Cl. CPC C09K 3/14

(57) ABSTRACT

Embodiments relate to the field of superhard materials, and to a polycrystalline diamond compact (PDC) and a preparation method therefor, and a cemented carbide substrate. The cemented carbide substrate includes a binding phase and a tungsten carbide. The binding phase includes a cobalt and a metal additive. The metal additive is selected from one or more of nickel, chromium, manganese, molybdenum, tin, copper, palladium, silver, aluminum, and platinum. By introducing specific elements and controlling proportions of the elements, the corrosion-resistant binding phase is formed, thereby improving the corrosion resistance of the cemented carbide substrate. Due to that the corrosion-resistant binding phase changes the corrosion mechanism of the cemented carbide substrate, the changed corrosion mechanism is more adapted to the usage scenarios of the PDC, effectively improving the corrosion resistance and erosion resistance of the PDC, and thereby improving the service life of the PDC.

### FIELD

The present disclosure relates to the technical field of superhard materials, in particular to a polycrystalline diamond compact and a preparation method therefor, and a cemented carbide substrate.

### BACKGROUND

Polycrystalline Diamond Compact (PDC) is a superhard composite material composed of a polycrystalline diamond layer and a cemented carbide layer. Due to the extremely high wearability of the polycrystalline diamond layer and the impact toughness of the cemented carbide layer, the PDC is widely used in geology and petroleum drilling. In drilling work, there are great differences in the geological environment among different regions, and there are differences in the geological composition at different drilling depths, and at the same time the drilling work itself causes local high temperatures and substance inputs, all leading to complex chemical environments for the PDC during work. These complex chemical environments are severe corrosive environments for metals.

The PDC is installed on the drilling bit during the drilling work, and the PDC is used to cut the rock layer during high-speed rotation. During the cutting process, a mixed system of rock debris, diamond debris worn away, and mud forms erosion on the PDC. In the PDC, the cemented carbide substrate is the main part of corrosion. In the cemented carbide substrate, there is a binding phase composed of one or more transition metals. Compared to tungsten carbide (WC), the binding phase is more prone to be corrupted, thereby resulting in structural defects in the cemented carbide and affecting overall usability.

At present, mainly using a cobalt-base cemented carbide as a synthetic substrate. For WC—Co cemented carbide, galvanic corrosion is easily formed between the binder and carbide, promoting the dissolution of the binder and damaging the integrity of the microstructure. Chemical corrosion and erosion can damage the mechanical properties of the cemented carbide, leading to early failure. Due to the inherent brittleness of the tungsten carbide material, the strength of the tungsten carbide material is extremely sensitive to existing small defects. The local damage caused by corrosion and erosion, especially in the initial stage, leads to a rapid decrease in the strength. This damage mechanism combines with the erosion during the drilling process, expanding the local damage and reducing the usability and the service life of the PDC.

Therefore, the existing technology still needs to be improved and developed.

### SUMMARY

Considering the above-mentioned defects in the prior art, the present disclosure provides a polycrystalline diamond compact and a preparation method therefor, and a cemented carbide substrate, aiming to solve the problem that the existing cemented carbide substrate has poor corrosion causing a reduction of the usability and the service life of the PDC.

The technical solutions of the present disclosure are as follows:

A cemented carbide substrate includes a binding phase and a tungsten carbide; the binding phase includes a cobalt and a metal additive; the metal additive is selected from one or more of nickel, chromium, manganese, molybdenum, tin, copper, palladium, silver, aluminum, and platinum.

In some embodiments, a mass ratio of the binding phase to the cemented carbide substrate is 13%-20%.

In some embodiments, a mass ratio of the cobalt in the binding phase to the cemented carbide substrate is 0.5%-16%.

In some embodiments, a mass ratio of each metal additive in the binding phase to the cemented carbide substrate is 0.5%-16%.

In some embodiments, a mass ratio of the cobalt to the binding phase is 5%-95%.

In some embodiments, a mass ratio of the metal additive to the binding phase is 5%-95%.

A polycrystalline diamond compact includes a polycrystalline diamond layer and a cemented carbide substrate.

A preparation method for the polycrystalline diamond compact includes steps of:
mixing a diamond formula powder to obtain a mixed powder;
placing the cemented carbide substrate on and above the mixed powder to obtain an assembly block;
sintering the assembly block to obtain the polycrystalline diamond compact.

In some embodiments, a temperature during the sintering process is 1400˜2000° C., a pressure during the sintering process is 5-10 GPa, and a duration during the sintering process is 5-60 minutes.

Beneficial effects of the present disclosure: the present disclosure provides a polycrystalline diamond compact and a preparation method therefor, and a cemented carbide substrate. The cemented carbide substrate includes a binding phase and a tungsten carbide. The binding phase includes a cobalt and a metal additive. The metal additive is selected from one or more of nickel, chromium, manganese, molybdenum, tin, copper, palladium, silver, aluminum, and platinum. In the present disclosure, the corrosion-resistant binding phase is formed by introducing specific elements and controlling proportions of the elements, thereby the corrosion resistance of the cemented carbide substrate is improved. Due to that the corrosion mechanism of the cemented carbide substrate is changed by the corrosion-resistant binding phase, and the changed corrosion mechanism is more adapted to the usage scenarios of the PDC, effectively improving the corrosion resistance and erosion resistance of the PDC, and thereby improving the service life of the PDC.

### BRIEF DESCRIPTION OF THE DRAWINGS

FIG. 1 is a schematic diagram of a cross-sectional structure of a PDC of the present disclosure;

FIG. 2 is a comparison diagram of a weight loss of a PDC subjected to oscillatory erosion for 100 hours among embodiments 1, 2, 3, and 4 of the present disclosure;

FIG. 3 is a comparison diagram of a weight loss of a PDC subjected to constant-temperature corrosion for 100 hours among embodiments 1, 2, 3, and 4 of the present disclosure;

FIG. 4 is a comparison diagram of a weight loss of a PDC subjected to constant-temperature corrosion for 100 hours in a pH 4.0 environment among embodiments 1, 2, 3, and 4 of the present disclosure.

### DETAILED DESCRIPTION OF EMBODIMENTS

The present disclosure provides a polycrystalline diamond compact and a preparation method therefor, and a cemented carbide substrate. In order to make the purposes, technical schemes, and effects of the present disclosure clearer and more specific, the present disclosure is further explained in detail below. It should be understood that the specific embodiments described here are only intended to explain the present disclosure and are not intended to limit the present disclosure.

Those skilled in the art can understand that, unless otherwise defined, all terms (including technical and scientific terms) used here, unless otherwise defined, have the same meaning as the skilled in the art to which the present disclosure belongs. It should also be understood that terms such as those defined in general dictionaries should be understood to have meanings consistent with those in the context of existing technology; And the terms, unless specifically defined in the present disclosure, are not interpreted with idealized or overly formal meanings.

The present disclosure provides a cemented carbide substrate including a binding phase and a tungsten carbide. The binding phase includes a cobalt and a metal additive. The metal additive is selected from one or more of nickel, chromium, manganese, molybdenum, tin, copper, palladium, silver, aluminum, and platinum.

In the present embodiment, a corrosion-resistant binding phase is formed by introducing specific elements and controlling proportions of the elements, thereby a corrosion resistance of the cemented carbide substrate is improved. By using the cobalt and the one or more of nickel, chromium, manganese, molybdenum, tin, copper, palladium, silver, aluminum, and platinum as the binding phase of the cemented carbide substrate. The binding phase and the tungsten carbide form the cemented carbide substrate, making the binding phase change a corrosion mechanism of the cemented carbide substrate, so that the changed corrosion mechanism is more adapted to the usage scenarios of PDC, effectively improving the corrosion resistance and erosion resistance of the PDC, and thereby improving the service life of the PDC.

In some embodiments, a mass ratio of the binding phase in the cemented carbide substrate to the cemented carbide substrate is 13%-20%. Controlling the mass ratio of the binding phase in the cemented carbide substrate to the cemented carbide substrate between 13% and 20% can improve a binding strength between raw materials of the cemented carbide substrate, making the cemented carbide substrate have high strength and less prone to cracking during use, while also improving a wearability of the cemented carbide substrate.

In some embodiments, a mass ratio of the cobalt in the binding phase to the cemented carbide substrate is 0.5%-16%. The cobalt mainly plays a catalytic role in the binding phase. Controlling the mass ratio of the cobalt in the cemented carbide substrate to the cemented carbide substrate to be between 0.5%-16% can improve the binding strength between the tungsten carbide.

In some embodiments, a mass ratio of each metal additive in the binding phase to the cemented carbide substrate is 0.5%-16%. By using one or more of nickel, chromium, manganese, molybdenum, tin, copper, palladium, silver, aluminum, and platinum as the metal additives of the binding phase, and by controlling the mass ratio of each metal additive to the cemented carbide substrate is 0.5%-16%, the cemented carbide substrate can have better corrosion resistance and erosion resistance, thereby improving the corrosion resistance of the cemented carbide substrate, further improving the service life of the PDC.

In some embodiments, a mass ratio of the cobalt to the binding phase is 5-95%. By controlling the mass ratio of the cobalt to the binding phase to be 5-95%, the cobalt can play a better catalytic role.

In some embodiments, a mass ratio of the total metal additives to the binding phase is 5-95%. By controlling the mass ratio of the total metal additives to the binding phase to be 5-95%, the cemented carbide substrate can have better corrosion resistance.

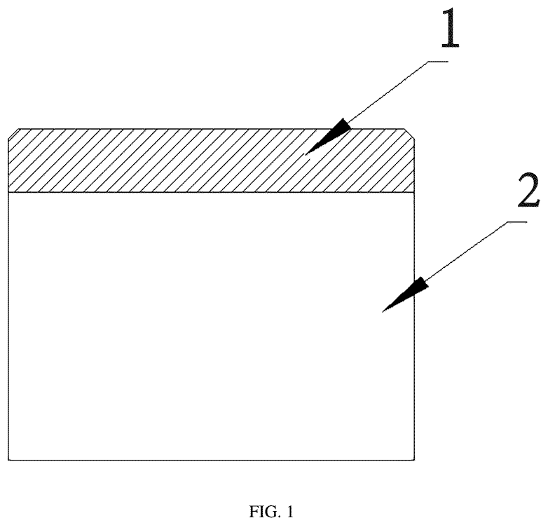

In addition, as shown in FIG. 1, the present disclosure further provides a PDC including a polycrystalline diamond layer 1 and a cemented carbide substrate 2.

The present embodiment uses the polycrystalline diamond layer and the cemented carbide substrate to prepare the PDC. Due to that the corrosion mechanism of the cemented carbide substrate is changed by the binding phase in the cemented carbide substrate, the changed corrosion mechanism is more adapted to the usage scenarios of the PDC, effectively improving the corrosion resistance and erosion resistance of the PDC, and thereby improving the service life of the PDC. Furthermore, using the cemented carbide substrate as the substrate of the PDC can make the PDC have high corrosion resistance, high hardness and better wearability, thereby improving the service life of the PDC and reducing production costs.

Furthermore, the present disclosure further provides a preparation method for the PDC, the method includes steps of:
step S10: mixing diamond formula powder to obtain mixed powder;
step S20: placing the cemented carbide substrate on and above the mixed powder to obtain an assembly block;
step S30: sintering the assembly block to obtain the PDC.

In some embodiments, by placing the mixed powder on and above the cemented carbide substrate in a metal cup, and by sintering the assembly block using high-temperature and high-pressure equipment, the PDC is obtained. The substrate of the PDC is the aforementioned cemented carbide substrate including a binding phase and a tungsten carbide. The binding phase includes a cobalt and a metal additive. The metal additive is selected from one or more of nickel, chromium, manganese, molybdenum, tin, copper, palladium, silver, aluminum, and platinum. A corrosion mechanism of the cemented carbide substrate is changed by the binding phase, improving the corrosion resistance and erosion resistance of the PDC.

Furthermore, the cemented carbide substrate of the PDC includes a corrosion-resistant binding phase including a cobalt and at least one metal additive. The corrosion-resistant binding phase changes a dominant corrosion mechanism, so that the cemented carbide substrate has better corrosion resistance.

In some embodiments, in the step S20, first introducing the mixed powder into a metal cup, and flattening the mixed powder, and placing the cemented carbide substrate in the metal cup, and positioning the cemented carbide substrate above the mixed powder to obtain the assembly block.

In some embodiments, a temperature during the sintering process is 1400˜2000° C., a pressure during the sintering process is 5-10 GPa, and a duration during the sintering process is 5-60 minutes. Under this condition, sintering the assembly block can obtain the PDC with better corrosion resistance, better impact resistance, and high wearability.

In some embodiments, the step S30 further includes steps of placing the assembly block in pyrophyllite, and placing the assembly block and the pyrophyllite in a high-pressure equipment for sintering to obtain a semi-manufactured PDC, and processing the semi-manufactured PDC to a target size to obtain the PDC.

Some embodiments are further provided below to explain the present disclosure in detail. It should also be understood that the following embodiments are only for further explanation of the present disclosure and cannot be understood as limiting the protection scope of the present disclosure. Some non-essential improvements and adjustments made by those skilled in the art based on the content of the present disclosure belong to the protection scope of the present disclosure.

### Embodiment 1

The present embodiment provides a PDC including a polycrystalline diamond layer and a cemented carbide substrate. 14% wt (weight) of the cemented carbide substrate is cobalt being as a binding phase, and the remaining of the cemented carbide substrate is a tungsten carbide. Sintering the polycrystalline diamond layer and the cemented carbide substrate for 10 minutes under a temperature of 1400° C. and a pressure of 7.5 GPa to obtain a PDC.

### Embodiment 2

The present embodiment provides a PDC including a polycrystalline diamond layer and a cemented carbide substrate. 14% wt of the cemented carbide substrate is a binding phase, the binding phase includes 7% wt cobalt and 7% wt nickel, and the remaining of the cemented carbide substrate is a tungsten carbide. Sintering the polycrystalline diamond layer and the cemented carbide substrate for 10 minutes under a temperature of 1400° C. and a pressure of 7.5 GPa to obtain a PDC.

### Embodiment 3

The present embodiment provides a PDC including a polycrystalline diamond layer and a cemented carbide substrate. 14% wt of the cemented carbide substrate is a binding phase, the binding phase includes 9% wt cobalt and 5% wt chromium, and the remaining of the cemented carbide substrate is a tungsten carbide. Sintering the polycrystalline diamond layer and the cemented carbide substrate for 10 minutes under a temperature of 1400° C. and a pressure of 7.5 GPa to obtain a PDC.

### Embodiment 4

The present embodiment provides a PDC including a polycrystalline diamond layer and a cemented carbide substrate. 14% wt of the cemented carbide substrate is a binding phase, the binding phase includes 9% wt cobalt, 2.5% wt nickel and 2.5% wt aluminum, and the remaining of the cemented carbide substrate is a tungsten carbide. Sintering the polycrystalline diamond layer and the cemented carbide substrate for 10 minutes under a temperature of 1400° C. and a pressure of 7.5 GPa to obtain a PDC.

By conducting wear-resistant, heat-resistant, and impact-resistant tests on the PDC prepared in the embodiments 1-4, the final results indicate that under the same testing conditions, the PDC prepared in the embodiments 1-4 have similar wearability, heat resistance, and impact resistance.

Considering the working state and environment of the drill bit, different tests are conducted on the corrosion resistance of the PDC.

Considering the working state of the drill bit during operation, the corrosion resistance of the PDC is tested through an oscillatory erosion. An environment of the oscillatory erosion is simulated by a combined action of an oscillatory motor and silica sand suspension.

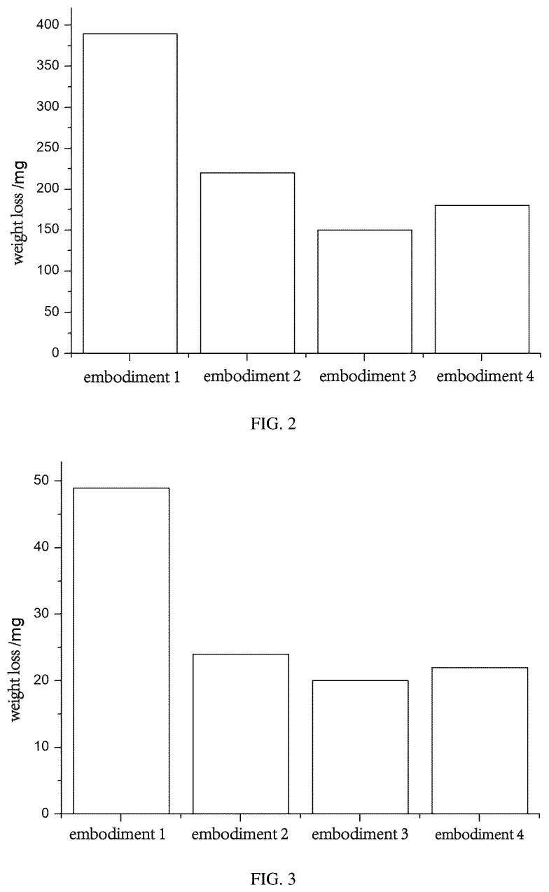

FIG. 2 is a comparison diagram of a weight loss of a PDC subjected to oscillatory erosion for 100 hours among embodiments 1, 2, 3, and 4 of the present disclosure. As shown in FIG. 2, in an erosion environment, weight loss is used as a characterization of corrosion resistance. Embodiment 1 loses 390 mg of weight during testing, wherein a weight loss rate is 3.9 mg/h. Embodiment 2 loses 220 mg of weight during testing, wherein a weight loss rate is 2.2 mg/h. Embodiment 3 loses 150 mg of weight during testing, wherein a weight loss rate is 1.5 mg/h. Embodiment 4 loses 180 mg of weight during testing, wherein a weight loss rate is 1.8 mg/h. The weight loss rate of embodiments 2, 3, and 4 is lower than the weight loss rate of embodiment 1, indicating that the corrosion resistance of PDC is improved under the substance ratio in the binding phase of embodiments 2, 3, and 4.

Considering the working state of the drill bit during standby, the corrosion resistance of PDC is tested through a constant-temperature corrosion. A constant-temperature environment is formed through a constant-temperature water bath box, with a constant temperature of 80° C.

FIG. 3 is a comparison diagram of a weight loss of a PDC subjected to constant-temperature corrosion for 100 hours under a salt environment among embodiments 1, 2, 3, and 4 of the present disclosure. As shown in FIG. 3, in an environment of constant-temperature corrosion, weight loss is used as a characterization of corrosion resistance. Embodiment 1 loses 49 mg of weight during testing, wherein a weight loss rate is 0.49 mg/h. Embodiment 2 loses 24 mg of weight during testing, wherein a weight loss rate is 0.24 mg/h. Embodiment 3 loses 20 mg of weight during testing, wherein a weight loss rate is 0.20 mg/h. Embodiment 4 loses 22 mg of weight during testing, wherein a weight loss rate is 0.22 mg/h. The weight loss rate of embodiments 2, 3, and 4 is lower than the weight loss rate of embodiment 1, indicating that the corrosion resistance of PDC is improved under the substance ratio in the binding phase of embodiments 2, 3, and 4.

Considering the working state of the drill bit under a severe environment, the corrosion resistance of PDC is tested through a constant-temperature corrosion. A constant-temperature environment is formed through a constant-temperature water bath box, with a constant temperature of 80° C. And a pH value of a mixed solution is 4.0.

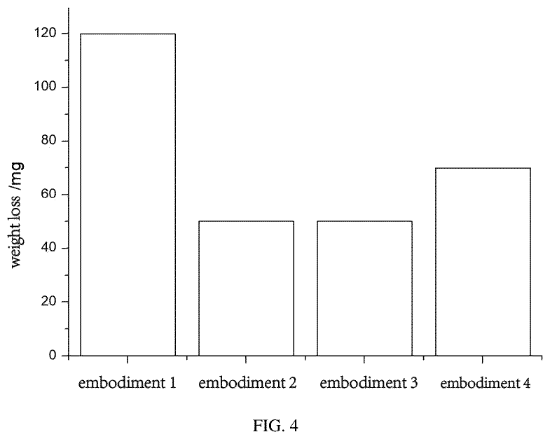

FIG. 4 is a comparison diagram of a weight loss of a PDC subjected to constant-temperature corrosion for 100 hours in a pH 4.0 environment among embodiments 1, 2, 3, and 4 of the present disclosure. As shown in FIG. 4, in an environment of constant-temperature corrosion and pH 4.0, weight loss is used as a characterization of corrosion resistance. Embodiment 1 loses 120 mg of weight during testing, wherein a weight loss rate is 1.2 mg/h. Embodiment 2 loses 50 mg of weight during testing, wherein a weight loss rate is 0.5 mg/h. Embodiment 3 loses 50 mg of weight during testing, wherein a weight loss rate is 0.5 mg/h. Embodiment 4 loses 70 mg of weight during testing, wherein a weight loss rate is 0.7 mg/h. The weight loss rate of embodiments 2, 3, and 4 is lower than the weight loss rate of embodiment 1, indicating that the corrosion resistance of PDC is improved under the substance ratio in the binding phase of embodiments 2, 3, and 4.

In summary, the present disclosure provides a polycrystalline diamond compact and a preparation method therefor, and a cemented carbide substrate. The cemented carbide substrate includes a binding phase and a tungsten carbide. The binding phase includes a cobalt and a metal additive. The metal additive is selected from one or more of nickel, chromium, manganese, molybdenum, tin, copper, palladium, silver, aluminum, and platinum. In the present disclosure, the corrosion-resistant binding phase is formed by introducing specific elements and controlling proportions of the elements, thereby the corrosion resistance of the cemented carbide substrate is improved. Due to that the corrosion mechanism of the cemented carbide substrate is changed by the corrosion-resistant binding phase, and the changed corrosion mechanism is more adapted to the usage scenarios of the PDC, effectively improving the corrosion resistance and erosion resistance of the PDC, and thereby improving the service life of the PDC.

It should be understood that the application of the present disclosure is not limited to the above embodiments. For those skilled in the art, improvements or modifications can be made according to the above description, and all these improvements and modifications fall within the protection scope of the claims attached to the present disclosure.

1-9. (canceled)

10. A cemented carbide substrate, comprising: a binding phase and a tungsten carbide; and the binding phase comprises a cobalt and a metal additive; the metal additive is selected from one or more of nickel, chromium, manganese, molybdenum, tin, copper, palladium, silver, aluminum, and platinum.

11. The cemented carbide substrate according to claim 10, wherein a mass ratio of the binding phase to the cemented carbide substrate is 13%-20%.

12. The cemented carbide substrate according to claim 10, wherein a mass ratio of the cobalt in the binding phase to the cemented carbide substrate is 0.5%-16%.

13. The cemented carbide substrate according to claim 10, wherein a mass ratio of each metal additive in the binding phase to the cemented carbide substrate is 0.5%-16%.

14. The cemented carbide substrate according to claim 10, wherein a mass ratio of the cobalt to the binding phase is 5%-95%.

15. The cemented carbide substrate according to claim 10, wherein a mass ratio of the metal additive to the binding phase is 5%-95%.

16. A polycrystalline diamond compact, wherein the polycrystalline diamond compact comprises a polycrystalline diamond layer and the cemented carbide substrate according to claim 10.

17. A preparation method for the polycrystalline diamond compact according to claim 16, the preparation method comprises steps of:
mixing a diamond formula powder to obtain a mixed powder;
placing the cemented carbide substrate on and above the mixed powder to obtain an assembly block; and
sintering the assembly block to obtain the polycrystalline diamond compact.

18. The preparation method according to claim 17, wherein a temperature during the sintering process is 1400˜2000° C., a pressure during the sintering process is 5-10 GPa, and a duration during the sintering process is 5-60 minutes.
